(19) United States
(12) Patent Application Publication
(10) Pub. No.: US 2010/0295472 A1
(43) Pub. Date: Nov. 25, 2010

(54) Power supply for floating loads

(75) Inventors: Josh Wibben, Eden Prairie, MN (US); Robert Schuelke, Lakeville, MN (US); Kurt Kimber, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Polar Semiconductor, Inc., Bloomington, MN (US)

(21) Appl. No.: 12/800,057

(22) Filed: May 6, 2010

Related U.S. Application Data
(60) Provisional application No. 61/175,976, filed on May 6, 2009.
(60) Provisional application No. 61/255,408, filed on Oct. 27, 2009.
(60) Provisional application No. 61/258,891, filed on Nov. 6, 2009.

(51) Int. Cl. H05B 41/36; H02J 4/00

(52) U.S. Cl. 315/294; 307/31

(57) ABSTRACT

A power supply includes a current supply, a plurality of output channels, and a controller. Each of the output channels has a load and a channel switch with a reference voltage. All of the channel switches are referenced to the same reference voltage.

### CROSS-REFERENCE TO RELATED APPLICATION(S)

Reference is made to U.S. application Ser. No. ______ entitled “MULTIPLE OUTPUT POWER SUPPLY” filed on even date and assigned to the same assignee as this application.

This application claims priority from U.S. Provisional Application No. 61/175,976 filed May 6, 2009 and U.S. Provisional Application No. 61/255,408 filed Oct., 27, 2009.

The aforementioned Application Nos. ______, 61/175,976, and 61/255,408 are hereby incorporated by reference in their entirety.

### BACKGROUND

The reduction in size of electronic devices creates a need to minimize off chip circuitry components to reduce component cost and required board size. One of the larger elements typically required in a power supply for electronic devices is an inductor. When a device has multiple loads which have different power requirements, there are two typical options: use multiple power drivers which require multiple inductors, or find a way to use a single inductor for multiple loads.

Single inductor multiple output (SIMO) power supplies have been developed to meet the needs of multiple loads. In a SIMO power supply, each channel is individually controlled with a channel switch. Existing designs have been developed to meet the needs of voltage based loads that require regulated voltage and are ground referenced. These power supplies place the channel switch at the highest potential in the circuit. In the case of current based loads such as light emitting diodes (LED)s, a ground reference is not required and the terminals can float with respect to the ground reference. A power supply that is designed to work with this type of load is desirable.

### SUMMARY

One aspect of the invention is a multiple output power supply including a current supply, a plurality of output channels connected to the current supply, and a controller. Each of the output channels includes a load and a channel switch with a reference voltage. The controller operates the channel switches to supply energy from the current supply to the loads. The channel switches all share the same reference voltage.

### BRIEF DESCRIPTION OF THE DRAWINGS

FIG. 1 is a circuit diagram of a boost mode single inductor multiple output (SIMO) power supply.

FIG. 1A is a circuit diagram of a variant of the boost mode SIMO power supply of FIG. 1.

FIG. 2 is an idealized circuit diagram for the boost mode SIMO power supply of FIG. 1.

FIG. 3 is a circuit diagram of a flyback SIMO power supply.

FIG. 4 is an idealized circuit diagram for the flyback SIMO power supply of FIG. 3.

FIG. 5 is a circuit diagram of a single ended primary inductor converter (SEPIC).

FIG. 6 is an idealized circuit diagram for the SEPIC of FIG. 5.

FIG. 7 is a circuit diagram of a variant of a SEPIC.

FIG. 8 is a circuit diagram of a boost integrated flyback rectifier/energy storage DC-DC (BIFRED) converter

FIG. 9 is a circuit diagram of a Cuk converter power.

FIG. 10 is a circuit diagram of a single switch buckboost-buck converter.

FIG. 11 is a circuit diagram of a buck-boost converter.

FIG. 12 is a circuit diagram of a variant of a buck-boost converter.

FIG. 13 is a circuit diagram of a buck converter.

FIG. 14 is a circuit diagram of a forward converter.

FIG. 15 is a circuit diagram of a half-bridge converter.

FIG. 16 is a circuit diagram of a non-isolated variation of the half-bridge converter.

FIG. 17 is a circuit schematic of a boost mode multiple inductor multiple output power supply.

FIG. 18 is a variant of the buck converter power supply of FIG. 13 using positively referenced controller and channel switches.

FIG. 19 is a timing diagram illustrating an alternating control method.

FIG. 20 is a timing diagram illustrating a multiplexed control method.

FIG. 21 is a timing diagram illustrating an alternating control method and its associated output voltage waveform.

### DETAILED DESCRIPTION

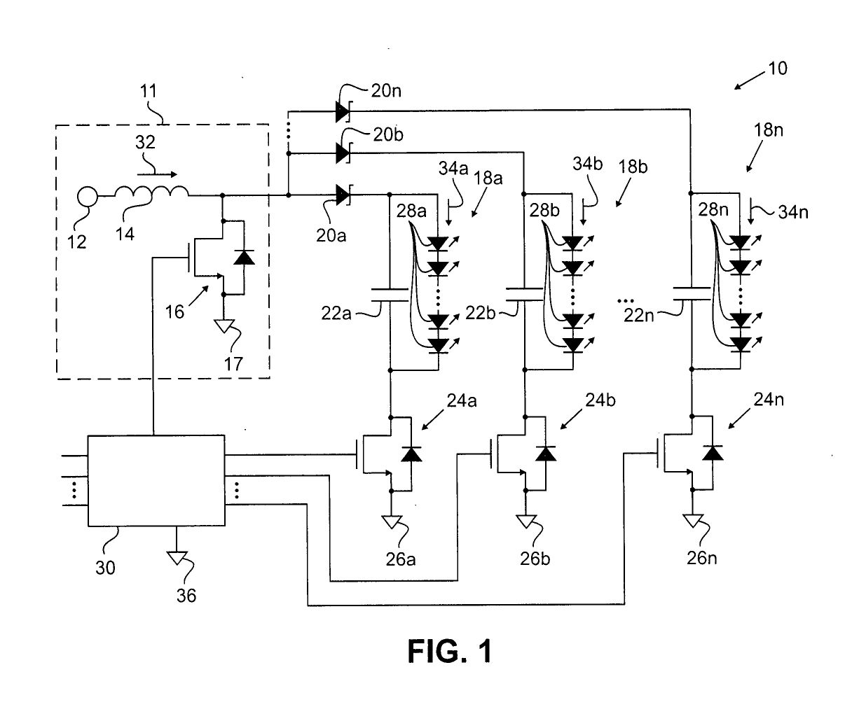

FIG. 1 illustrates a boost mode single inductor multiple output (SIMO) power supply shown as circuit 10. Circuit 10 is powered by current supply subcomponent 11. Current supply subcomponent 11 has voltage input 12 connected in series with single inductor 14. Single inductor 14 is connected to main switch 16 referenced to ground reference 17. Output channels 18a-18n are also connected to single inductor 14. Output channels 18a-18n have diodes 20a-20n connected in series with capacitors 22a-22n, and channel switches 24a-24n. Channel switches 24a-24n are referenced to ground references 26a-26n. Loads, shown as a string of LEDs 28a-28n, are connected in parallel with capacitors 22a-22n. Switches 16 and 24a-24n are controlled by controller 30 which also monitors inductor current 32 and load currents 34a-34n. Controller 30 is referenced to ground reference 36.

FIG. 1A illustrates a variant of the boost mode SIMO current supply depicted in FIG. 1. Circuit 10′ has diodes 20a′-20n′ located between loads 28a-28n and channel switch 24a-24n. It does not matter where the diode is placed in the series combination of each output channel. The output channel will still operate in the same way because the load is floating. The diode may be placed at the lowest potential of the load. Circuit 10′ offers identical operation as circuit 10 in FIG. 1.

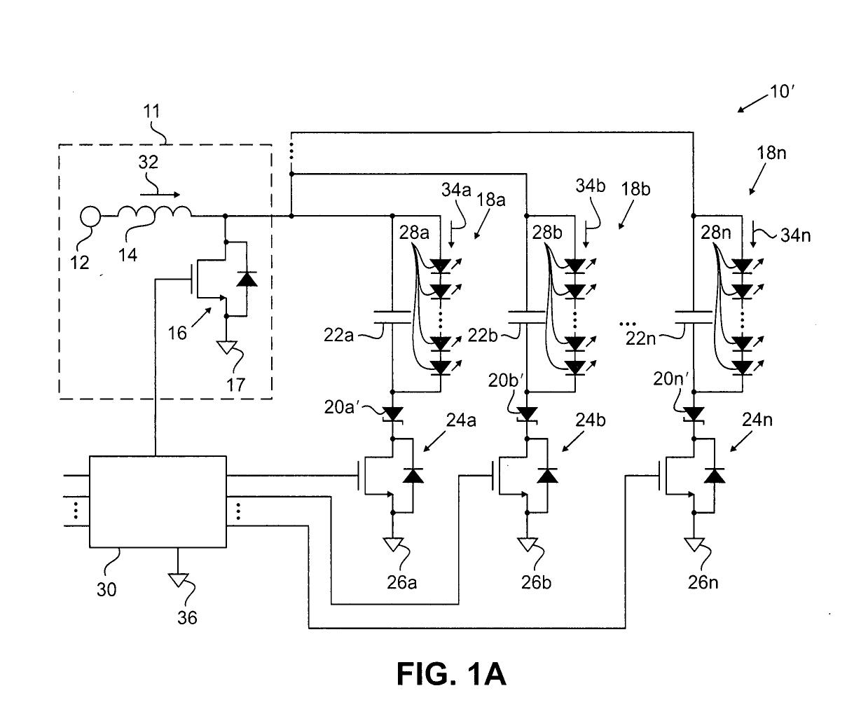

FIG. 2 illustrates an idealized circuit diagram for the boost mode SIMO power supply depicted in FIG. 1. Circuit 100 has current supply subcomponent 102 connected to output channels 104a-104n. Each channel includes LEDs that are modeled as voltage sources 106a-106n and ground referenced channel switches 108a-108n. Controller 110 is also ground referenced.

Circuits 10 and 100 operate in the same way and will be described with respect to the embodiment shown in FIG. 1. When main switch 16 is turned on, energy from voltage input 204 is stored in inductor 14. While main switch 16 is on diodes 20a-20n are reverse biased and prevent any energy from being delivered to the output channels 18a-18n. When main switch 16 is turned off, the diodes 20a-20n become forward biased delivering the energy from inductor 14 to an active output channel 18a-18n.

Generally, the active output channel is determined by the output channel that has its associated channel switch conducting. For circuit 100, the function of the channel diodes is performed with channel switches 108a-108n. In this configuration, all of the switches are operated in a non-overlapping fashion, only a period of time after the main switch turns off should channel switches 108a-108n be turned on. This prevents discharging the loads, while still enabling the transfer of energy from the inductor to the load.

Typical power supplies designed for voltage based loads must be ground reference and thus must have the channel switches placed at the highest potential of the circuit, which is near the current supply subcomponent. This means that the control signals provided by the controller to the channel switches would have to have a voltage sufficient to bias the channel switch. Floating loads do not require this configuration.

By referencing controller 30 and channel switches 24a-24n to the same reference, the control signals from controller 30 to channel switches 24a-24n only need to be of a sufficient magnitude to bias channel switches 24a-24n. With the channel switches on the low side and a positive output voltage, channel switches 24a-24n can be realized with NMOS devices which generally are more efficient than a PMOS devices. Controller 30 does not have to overcome the significant voltage present on LEDs 28a-28n. The controller also does not need to tolerate the different potentials present at each channel. Using the same reference for channel switches 24a-24n and controller 30 offers a higher performance and less costly implementation.

The invention can use a variety of different current supply subcomponent topologies in addition to the boost mode topology described with respect to FIGS. 1 and 2. Alternative embodiments using other possible current supply subcomponent topologies will now be discussed.

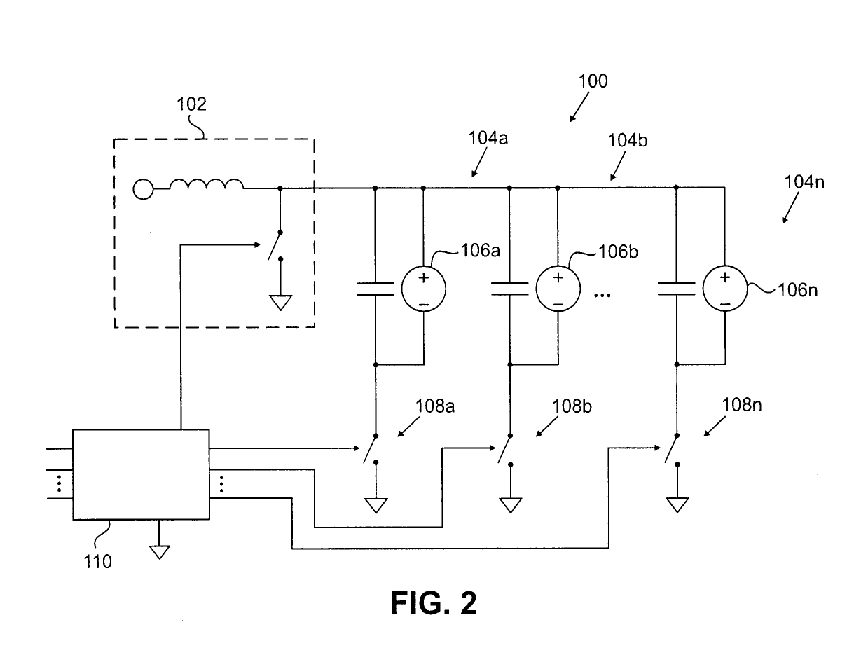

FIG. 3 illustrates a flyback SIMO power supply shown as circuit 200. Current supply subcomponent 202 has voltage input 204 connected with one side of coupled inductor 206 in series with main switch 208 and ground reference 210. The other side of coupled inductor 206 is connected with ground contact 212. This configuration is known as a flyback power supply. The output of current supply subcomponent 202 is connected through diodes 213a-213n to output channels 214a-214n. Output channels 214a-214n include channel switches 216a-216n which are referenced to ground references 218a-218n. Similar to the boost converter, when the flyback converter is configured with a positive output voltage, channel switches 216a-216n can be implemented with NMOS devices. The circuit is operated by controller 220 which is referenced to ground reference 222.

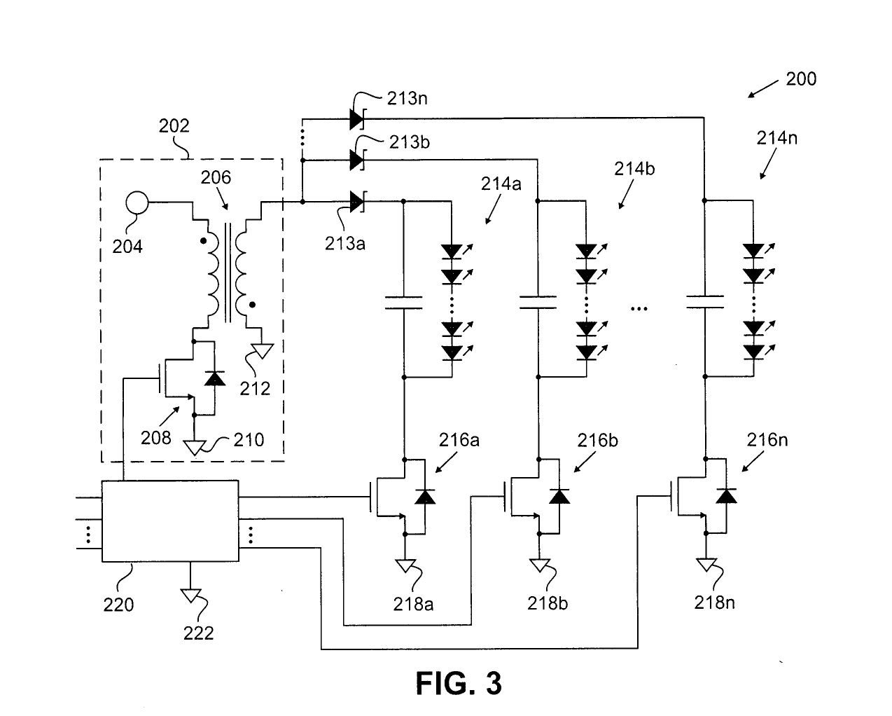

FIG. 4 illustrates an idealized circuit diagram for the flyback SIMO depicted in FIG. 3. Circuit 300 has current supply subcomponent 302 connected to output channels 304a-304n. Each channel includes LEDs that are modeled as voltage sources 306a-306n and ground referenced channel switches 308a-308n. Controller 310 is also ground referenced.

Circuits 200 of FIGS. 3 and 300 of FIG. 4 operate in the same way and will be described with respect to the embodiment shown in FIG. 3. When main switch 208 is turned on, energy from voltage input 204 is stored in the primary winding of coupled inductor 206. During this period, only the primary winding of coupled inductor 206 is active. The secondary winding of coupled inductor 206 is held in an open circuit condition either by ensuring channel switches 214z-214n are open or by the reverse bias of diodes 213a-213n caused by the voltage across the secondary winding of coupled inductor 206 going negative.

When main switch 208 is turned off, the energy that was stored in the primary winding of coupled inductor 206 will transfer to the secondary winding of coupled inductor 206. That energy is then released into one of output channels 214a-214n. To achieve this energy transfer, a single channel switch 218a-218n is turned on as main switch 208 is turned off in a non-overlapping fashion. The timing is less critical when diodes 213a-213n are employed as they will automatically forward bias after main switch 208 is turned off. In this case, the selected channel switch 218a-218n can be on while main switch 208 is turned on in preparation for the energy release from the secondary winding of coupled inductor 206.

The SIMO flyback can be implemented with or without electrical isolation between the primary and secondary sides of couple inductor 206. In an isolated embodiment, controller 220 is located on the secondary side of coupled inductor 206 and main switch 208 is driven with an isolated gate drive circuit. Those skilled in the art will recognize that isolation can be achieved in a variety of other ways including placing controller 220 on the primary side of coupled inductor 206. The flyback topology offers an advantage over the boost topology of being able to provide both a voltage step up and step down. Multiple secondary windings may be used to drive multiple loads.

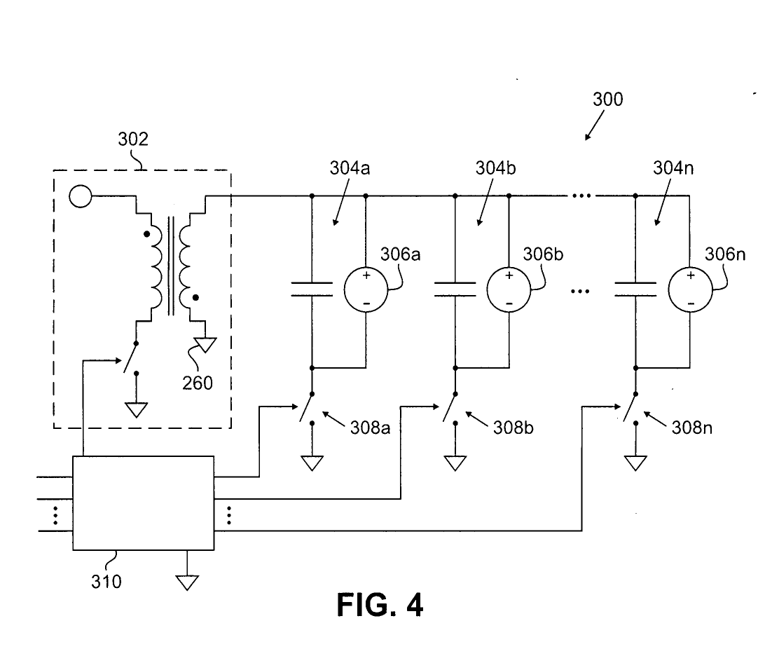

FIG. 5 illustrates another possible embodiment shown as circuit 400 which has a Single Ended Primary Inductor Converter (SEPIC) power supply. Current supply subcomponent 402 has voltage input 404 connected to the primary winding of coupled inductor 406. The primary winding of coupled inductor 406 is also connected to capacitor 408 and main switch 410. Main switch 410 is connected to ground reference 412. Capacitor 408 is connected to the secondary winding of coupled inductor 406 to ground contact 416. Capacitor 408 is also connected through diodes 417a-417n to output channels 418a-418n. Output channels 418a-418n include channel switches 420a-420n referenced to ground references 422a-422n. Channel switches 420a-420n are realized with NMOS devices. Circuit 400 is controlled by controller 424 which is referenced to ground reference 426. With a coupled inductor, the SEPIC is similar to a flyback but can achieve higher efficiencies due to its ability to clamp the voltage on the primary and secondary sides of coupled inductor 406 when isolation is not required. Alternatively, the SEPIC converter can also be implemented with two discrete inductors that are not coupled in place of coupled inductor 406.

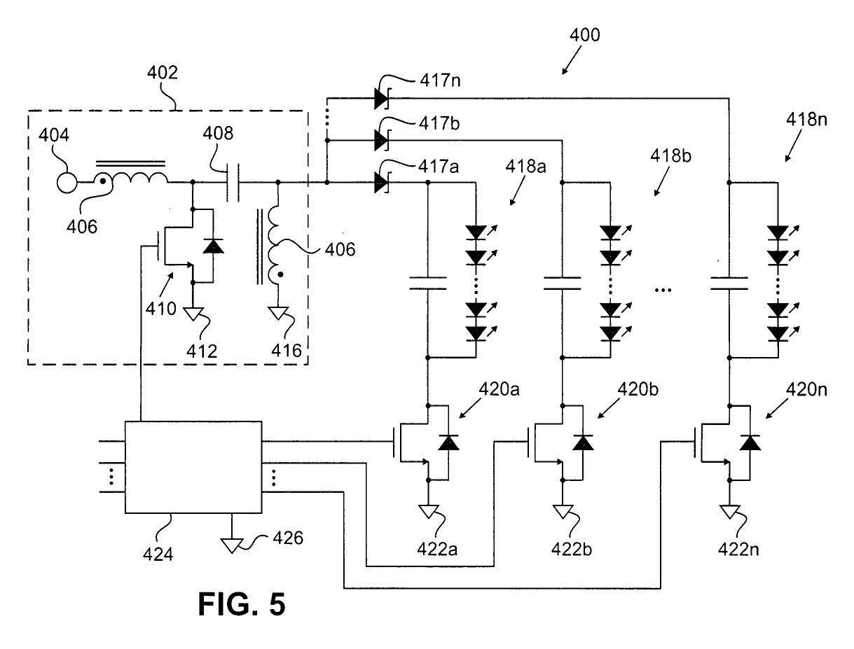

FIG. 6 illustrates an idealized circuit diagram for the SEPIC SIMO depicted in FIG. 5. Circuit 500 has current supply subcomponent 502 connected to output channels 504a-504n. Each channel includes LEDs that are modeled as voltage sources 506a-506n and ground referenced channel switches 508a-508n. Controller 510 is also ground referenced.

Circuits 400 of FIGS. 5 and 500 of FIG. 6 operate in the same way and will be described with respect to the embodiment shown in FIG. 5. A SEPIC converter is constructed with a boost converter on the input stage and a buck-boost converter on the output stage. When main switch 410 is turned on, the primary winding of coupled inductor 406 stores energy from voltage input 404 and the secondary winding of coupled inductor 406 stores energy from capacitor 408. While main switch 410 is turned on, there is no energy transferred to output channels 418a-418n. When main switch 410 is turned off, the energy stored in the primary winding of coupled inductor 406 is released through capacitor 408 to the selected output channel 418a-418n. The energy stored in the secondary winding is also released to the selected output channel 418a-418n when main switch 410 is turned off. Only one of output channels 418a-418n is enabled by channel switches 420a-420n at a time.

When main switch 410 is turned on, all of channel switches 420a-420n are turned off. Once main switch 410 is turned off, the channel switch 420a-420n for the active channel is turned on. Diodes 417a-417n are reverse biased when main switch 410 is turned on. Therefore, when diodes 417a-417n are included, channel switches 420a-420n can remain on when main switch 410 is on.

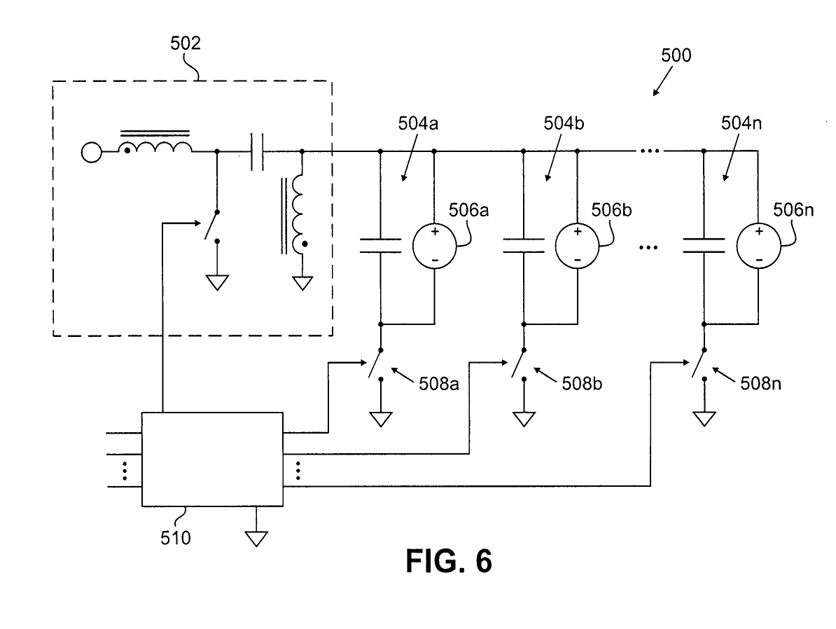

FIG. 7 illustrates a variant of the SEPIC power supply shown in FIG. 5. Circuit 600 has current supply subcomponent 602. Current supply subcomponent 602 includes voltage input 604 connected to diode 606. Diode 606 is connected to input inductor 608. Input inductor 608 is connected to main switch 610 and capacitor 612. Capacitor 612 is connected to output inductor 609 and to output channels 614a-614n through diodes 613a-613n. Output channels 614a-614n include ground referenced channel switches 616a-616n operated by ground referenced controller 618.

Diode 606 added to the input stage allows current supply subcomponent 602 to operate in discontinuous conduction mode (DCM) while the output stage operates in a continuous conduction mode (CCM). This mode of operation allows current supply subcomponent 602 to perform a power factor correction (PFC) function at the input while regulating the output at a DC voltage. Without the presence of diode 606, the continuous conduction of secondary inductor 609 causes the active output diode 613a-613n to continuously conduct forcing primary inductor 608 to operate in a continuous conduction mode with negative inductor current. Due to the different modes of operation between the input and output inductors, primary inductor 608 and secondary inductor 609 are generally not coupled.

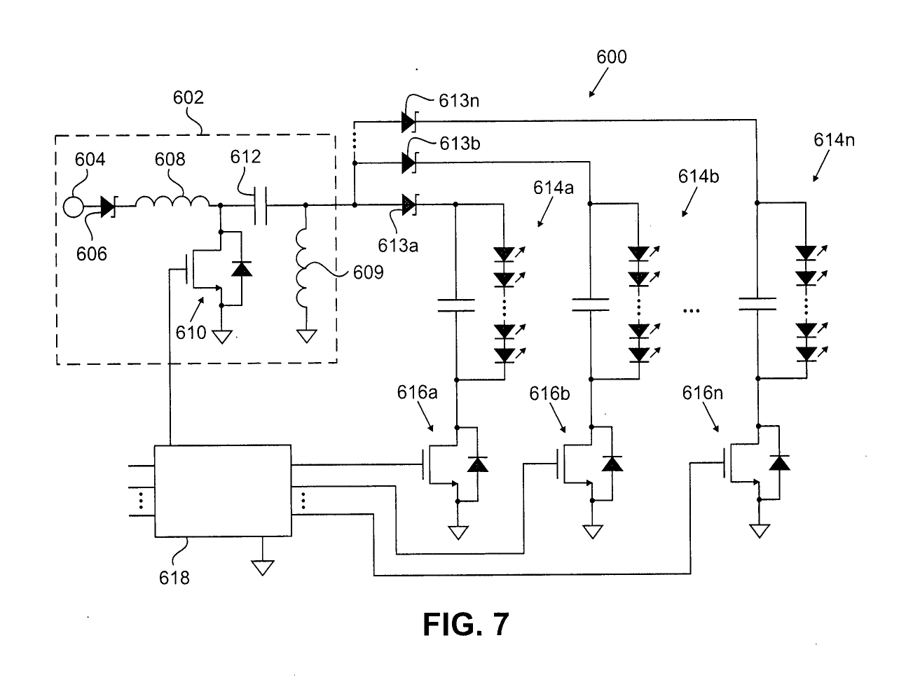

FIG. 8 illustrates another possible embodiment in the boost integrated flyback rectifier/energy storage DC-DC (BIFRED) converter of circuit 700. Current supply subcomponent 702 has voltage input 704 connected to diode 706. Diode 706 is connected to inductor 708. Inductor 708 is connected to main switch 710 and capacitor 712. Main switch 710 is connected to ground reference 714. Capacitor 712 is connected to the primary winding of coupled inductor 716 which is also connected to ground reference 718. The secondary winding of coupled inductor 716 is connected between ground reference 720 and diodes 722a-722n. Diodes 722a-722n are connected to output channels 724a-724n respectively. Output channels 724a-724n include ground referenced channel switches 726a-726n operated by ground referenced controller 728.

The BIFRED topology uses a flyback in the output stage to provide isolation. Isolation of the control circuitry can be achieved in the same manner as described for the flyback converter shown in FIG. 3. The BIFRED topology can also perform step up and step down conversions as well as provide power factor correction (PFC) with a single main switch 710.

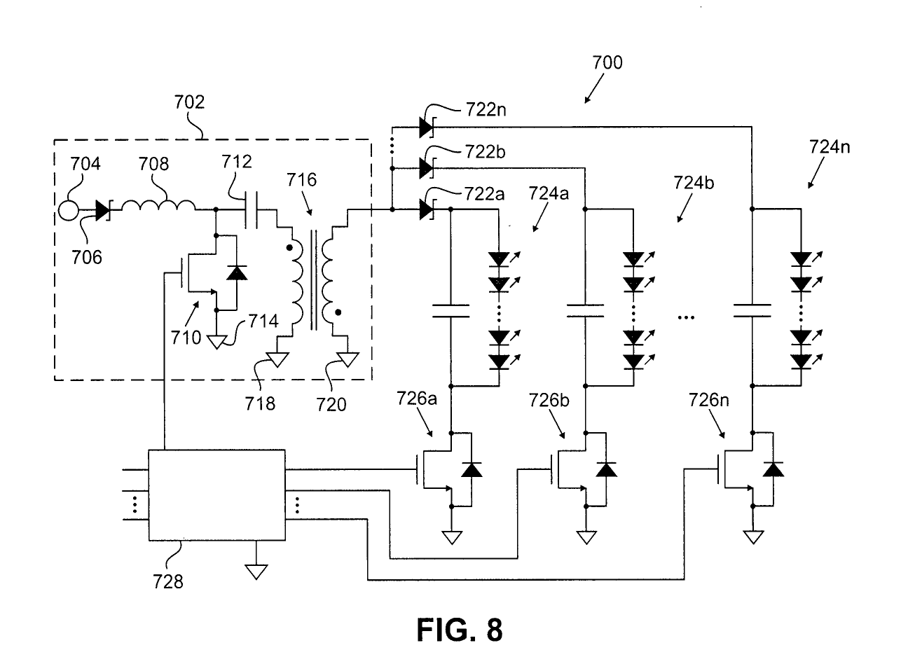

FIG. 9 illustrates an embodiment using a Cuk converter. Circuit 800 includes current supply subcomponent 802. Voltage input 804 is connected to inductor 806. Inductor 806 is connected to main switch 808 and capacitor 810. Main switch 808 is connected to ground reference 812. Capacitor 810 is connected to diode 814 and inductor 816. Diode 814 is connected to ground reference 818. Inductor 816 is connected through diodes 820a-820n to output channels 822a-822n. Output channels 822a-822n include ground referenced channel switches 824a-824n operated by ground referenced controller 826. The Cuk topology generates a negative output voltage and channels switches 824a-824n are realized with a PMOS device rather than the NMOS device depicted in the other embodiments. Also, due to the negative output voltage, diodes 820a-820n are reversed compared to previously shown embodiments.

The Cuk topology is similar to the SEPIC topology except that the output stage uses an inverted buck topology as opposed to a buck-boost topology. This results in a negative output voltage. The buck topology can offer better performance than the buck-boost topology by having a continuous current at the output and lower voltage stresses. Both the Cuk and the SEPIC use a boost topology on the input stage. Therefore, turning on main switch 808 still stores energy in inductor 806 from voltage input 804 and in inductor 816 from capacitor 810. While energy is being stored in inductor 816, the Cuk topology allows energy to be delivered to the active output channel 822a-822n. When main switch 808 is turned off, the energy that was stored in inductor 806 is released into capacitor 810 and the energy that was stored in inductor 816 is delivered to the active output channel 822a-822n.

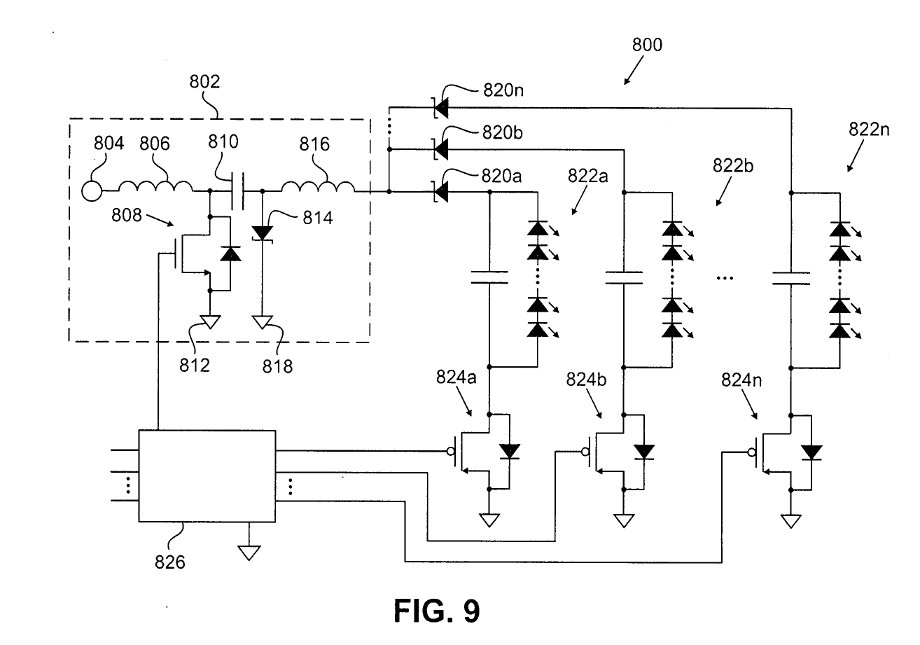

FIG. 10 illustrates an embodiment using a single switch buckboost-buck converter SIMO. Circuit 900 has current supply subcomponent 902. Current supply subcomponent 902 is similar to current supply subcomponent 802 of FIG. 9 with the addition of diodes 904, 906, and 908 to form a buck-boost input stage. Diode 904 is located between voltage input 910 and inductor 912. Diode 906 is located between voltage input 910 and capacitor 914. Diode 908 is located between capacitor 914 and inductor 916. Inductor 916 is connected through diodes 920a-920n to output channels 922a-922n. Output channels 922a-922n include ground referenced channel switches 924a-924n operated by controller 926.

This topology is a variant of the Cuk topology shown in FIG. 9. The buckboost-buck topology shares the output stage of the Cuk topology but has a different input stage using a buck-boost topology. With a fixed duty cycle, the buck-boost topology offers improved power factor correction at its input. When main switch 918 is turned on, energy is stored in inductor 912 from voltage input 910. But, when main switch 918 is turned off and the energy is released into capacitor 810, none of the current associated with the energy transfer passes through voltage input 910. Instead, it circulates through diode 906. The improved power factor correction is realized because the input current is only dependant on the voltage input supply and not the voltage on capacitor 914 or the output due to the circulation of the current through diode 906. Due to sharing the same output stage of the Cuk topology, and for the same reasoning, circuit 900 has the same implementation for its channel switches 924a-924n as the Cuk

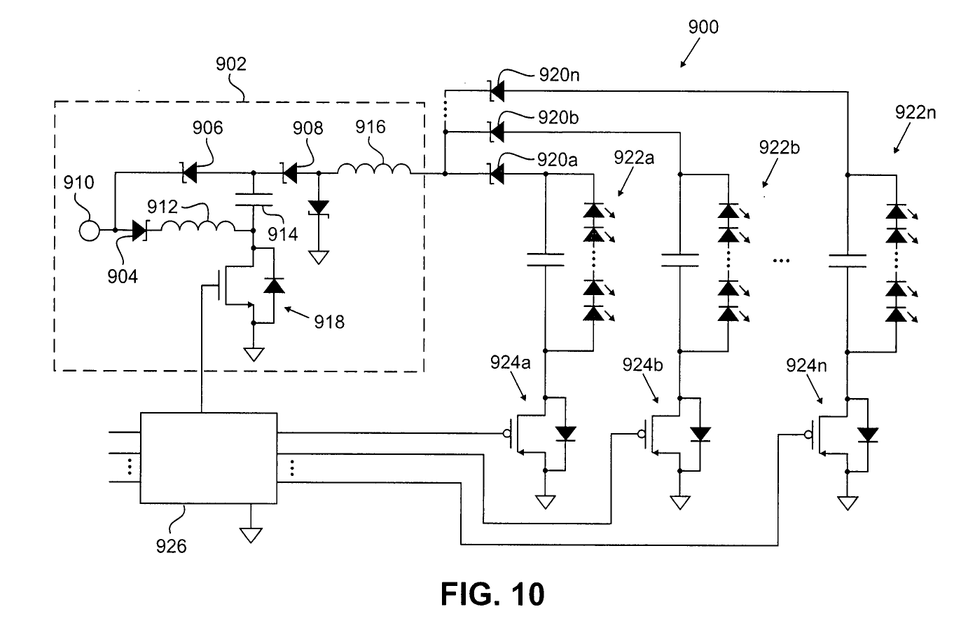

FIG. 11 illustrates an embodiment shown as circuit 1000 which has a buck-boost power supply. Current supply subcomponent 1002 has voltage input 1004 connected to main switch 1006. Main switch 1006 is connected to inductor 1008 and diodes 1010a-1010n. Inductor 1008 is connected to ground reference 1012. Diodes 1010a-1010n are connected to output channels 1014a-1014n respectively. Output channels 1014a-1014n include ground referenced channel switches 1016a-1016n which are controlled by ground referenced controller 1018. Similar to Cuk topology the channel switches 1016a-1016n are implemented with PMOS devices and channel diodes 1010a-1010n are reversed due to the negative output voltage.

This buck-boost topology is similar to the Cuk topology in that it also generates a negative voltage at its output. It has fewer components that other topologies but it can still perform step down and step up conversions. When main switch 1006 is turned on, energy is stored in inductor 1008 from voltage input 1004. When main switch 1006 is turned off, that energy is then released into the active output channel 1014a-1014n.

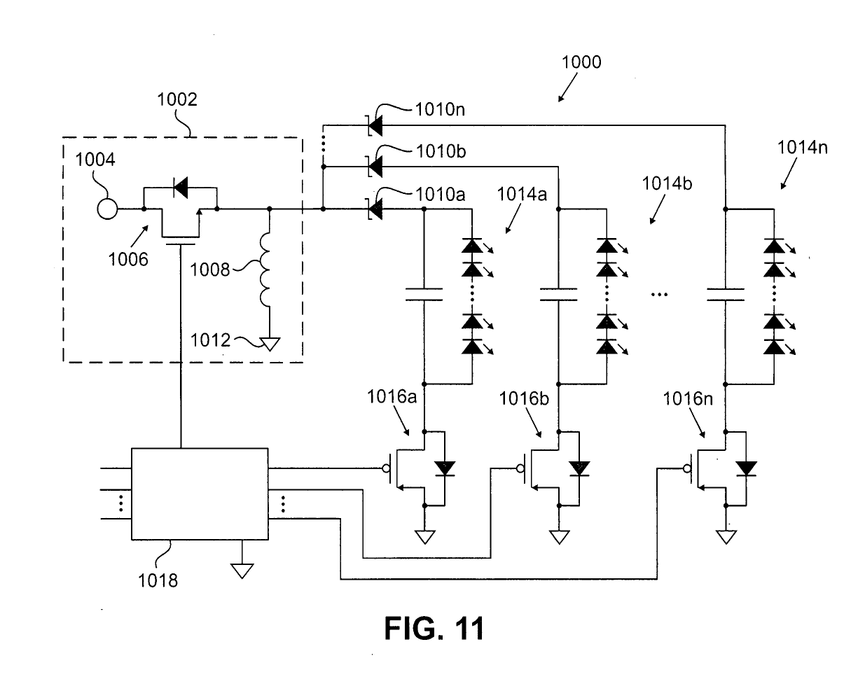

FIG. 12 illustrates a variant of the buck-boost power supply shown as circuit 1050 which implements the buck-boost functionality with a freewheel switch. Current supply subcomponent 1052 includes voltage input 1054 connected in series with high main switch 1056a, synchronous rectifier 1056b, and ground reference 1060. Inductor 1062 is connected between high main switch 1056a and synchronous rectifier 1056b on one terminal and freewheel switch 1056c on the other terminal. Freewheel switch 1056c is connected to ground reference 1058. Inductor 1062 is also connected through diodes 1063a-1063n to output channels 1064a-1064n. Output channels 1064a-1064n include ground referenced channel switches 1066a-1066n operated by ground referenced controller 1068. This implementation of a buck-boost generates a positive output voltage and therefore the channel switches 1066a-1066n are implemented with NMOS devices and the channel diodes 1064a-164n are oriented in the same direction as the boost of FIG. 1.

This current supply subcomponent construction can be operated in buck, boost, or buck-boost modes of operation. To achieve the freewheel function, synchronous rectifier 1056b and freewheel switch 1056c are closed. During boost operation, high main switch 1056a remains on and synchronous rectifier 1056b remains off, while freewheel switch 1056c is switched to store and release the energy in inductor 1062. For buck-boost operation, energy is stored in inductor 1062 by closing high main switch 1056a and freewheel switch 1056c. The energy is then released by opening the previously closed switches and turning on synchronous rectifier 1056b. For buck operation, freewheel switch 1056c remains open while high main switch 1056a turns on and synchronous rectifier 1056b is off to store energy in inductor 1062. Inductor 1062 is discharged by opening high main switch 1056a and closing synchronous rectifier 1056b.

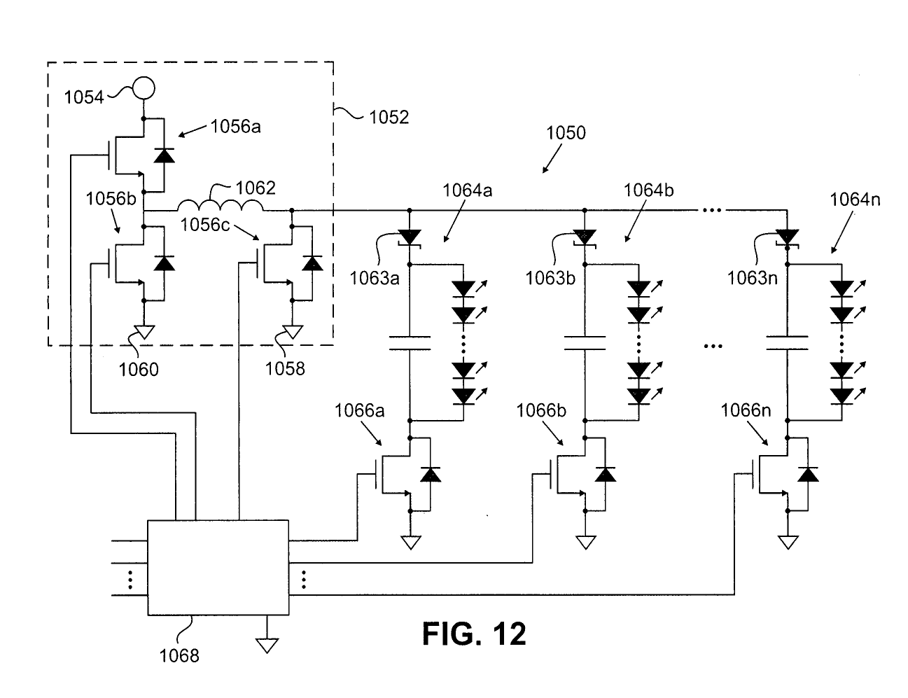

FIG. 13 illustrates an embodiment shown as circuit 1100 which has a buck converter power supply. Current supply subcomponent 1102 has voltage input 1104 connected to main switch 1106. Main switch 1106 is connected to freewheel diode 1108 and inductor 1110. Diode 1108 is connected to ground reference 1112. Inductor 1110 is connected through diodes 1114a-1114n to output channels 1116a-1116n. Output channels 1116a-1116n include ground referenced channel switches 1118a-1118n operated by ground referenced controller 1120 implemented with NMOS devices due to the positive output voltage.

The buck converter is an efficient way of performing a step down conversion due to its low voltage stress and continuous current at the output. When main switch 1106 is turned on, energy is stored in inductor 1110 and directed to the active output channel 1116a-1116n. When main switch 1106 is turned off, energy stored in inductor 1110 is released to the active output channel 1116a-1116n. In this embodiment, main switch 1106 can be driven using a bootstrap circuit or any of a variety of other known techniques. Freewheel diode 1108 can also be a synchronous rectifier. Diodes 1114a-1114n are present to prevent the parasitic diodes in channel switches 1118a-1118n from conducting when one of output channels 1116a-1116n with a lower potential is active.

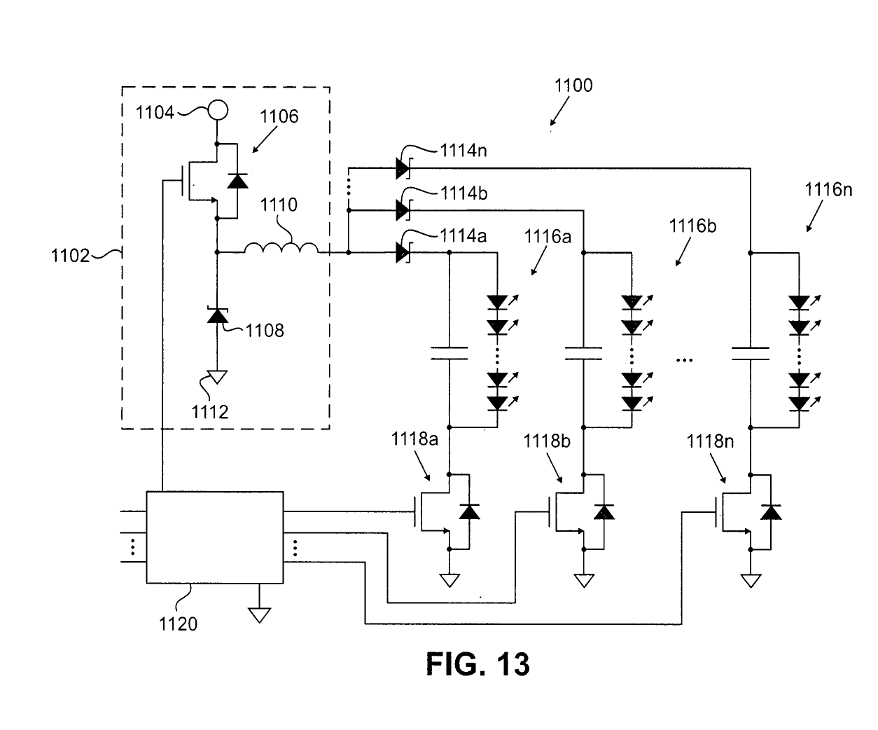

FIG. 14 illustrates another possible embodiment shown as circuit 1200 which has a forward converter power supply. Current supply subcomponent 1202 includes voltage input 1204 connected to the first and second windings of three winding transformer 1206. The first winding of transformer 1206 is also connected to main switch 1208. The second winding of transformer 1206 is also connected through diode 1208 to ground contact 1210. The third winding of transformer 1206 is connected to ground contact 1212 and diode 1214. Diode 1214 is connected to inductor 1216 and through diode 1218 to ground contact 1220. Inductor 1216 is connected though diodes 1222a-1222n to output channels 1224a-1224n. Output channels 1224-1224n include ground referenced channel switches 1226a-1226n, implemented with NMOS devices due to the positive output voltage, and operated by ground referenced controller 1228.

The output stage of a forward converter resembles a buck converter with the addition of transformer 1206 to provide isolation or assist in step down. When main switch 1208 is turned on, energy from voltage input 1204 passes through transformer 1206 and diode 1214 to be stored in inductor 1216 and supplied to the active output channel 1224a-1224n. Then main switch 1208 turns off, the energy stored in inductor 1216 is delivered to the active output channel 1224a-1224n due to the presence of diode 1218. To prevent energy from building up in transformer 1206, diode 1208 becomes forward biased when main switch 1208 is turned off to discharge magnetic flux stored in transformer 1206.

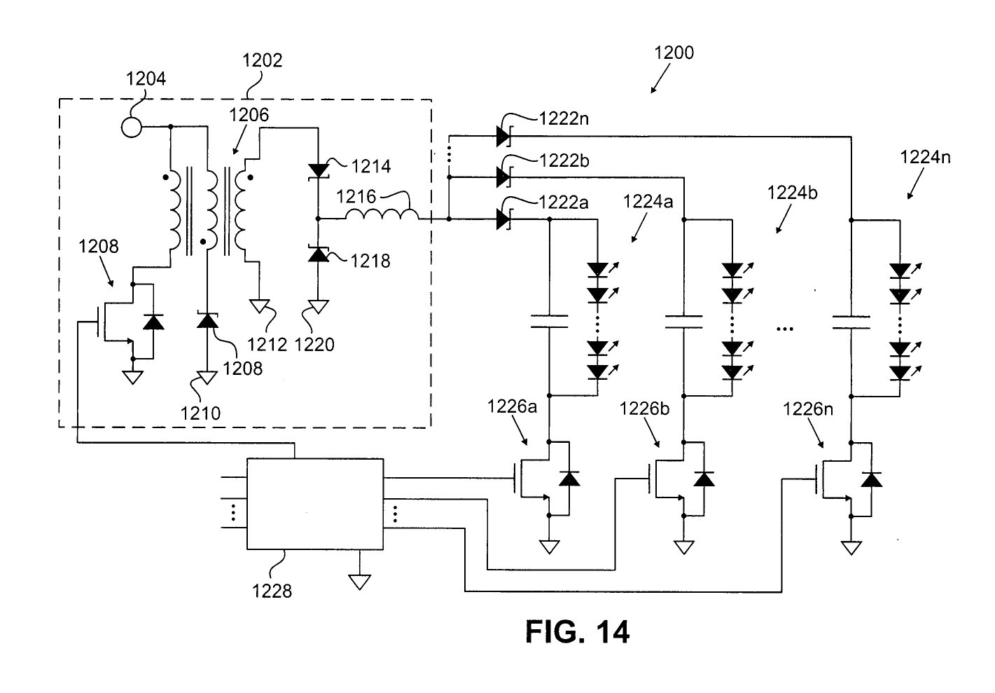

FIG. 15 illustrates an embodiment using a half-bridge converter power supply. Circuit 1300 has current supply subcomponent 1302. Voltage input 1304 is connected to high main switch 1306. High main switch 1306 is connected to inductor 1308 and low main switch 1310. Inductor 1308 is connected to capacitor 1312 which is connected to the first side of transformer 1314. Transformer 1314 has a center tap on the second side and has diodes 1316 and 1318 connected to the end terminals. Diodes 1316 and 1318 are also connected to ground reference 1320. The center tap of transformer 1206 is connected through diodes 1322a-1322n to output channels 1324a-1324n. Output channels 1324a-1324n include ground referenced channel switches 1326a-1326n operated by ground referenced controller 1328. When the forward converter is configured with a positive output voltage channel switches 1326a-1326n can be implemented with NMOS devices.

The half-bridge converter is a variant of the forward converter that makes use of transformer 1314 in both positive and negative directions. The half-bridge topology operates at a fixed 50% duty cycle and varies the frequency to regulate the output. A 50% duty cycle is used to ensure the voltage across capacitor 1312 is half of the voltage from voltage input 1304. Inductor 1308 must conduct negative currents. Therefore, instead of a freewheel diode, bidirectional low main switch 1310 is used. High main switch 1306 is similar to that used in a buck topology and can be driven using a bootstrap circuit.

When high main switch 1306 is turned on, a positive voltage is applied to inductor 1308 which causes it to ramp up. During this cycle, the inductor current starts negative, crosses zero, and continues positive. Transformer 1314 replicates this positive current from the primary side to the secondary supply. At the beginning of the cycle, diode 1316 is on. When the inductor current goes positive, diode 1316 turns off and diode 1318 turns on.

When high main switch 1306 is turned off and low main switch 1310 is turned on, a negative voltage is applied to inductor 1308 due to the voltage on capacitor 1312. This negative voltage causes the inductor current to ramp down from a positive to a negative magnitude. Initially, diode 1318 conducts, but once the current crosses zero, diode 1318 turns off and diode 1316 turns back on.

A difference between the forward converter of FIG. 14 and the half-bridge converter of FIG. 15 is the location of the filter. For the forward converter, the filter is on the secondary side causing the inductor to be multiplexed. For the half-bridge converter, the filter is on the primary side causing the transformer to be multiplexed. These arrangements are shown in this manner for exemplary purposes. In either topology, the filter may be located on either side. The function of the inductor may also be realized utilizing properties of the transformer.

The half-bridge converter can be isolated or non-isolated as well resonant or non-resonant. A wide variety of switch realizations are possible for both the forward and half-bridge topologies. Forward converters can use a two switch technique that demagnetizes the transformer with a single primary winding as opposed to two primary windings.

The voltage divider aspect of the half-bridge can be implemented with two capacitors forming a divider between the voltage input and the ground reference. This functionality can also be achieved using a push-pull technique that uses two primary windings and two switches in place of the capacitors.

An extension of the half-bridge topology is the full-bridge topology which uses four switches to provide more flexible control. The full-bridge topology is more efficient for higher power applications. The full wave rectifier on the secondary side of these topologies can be implemented in a variety of ways including the use of a full wave rectifier implemented as a stand alone rectifier or as a part of the channel diodes. This latter embodiment is shown in FIG. 15.

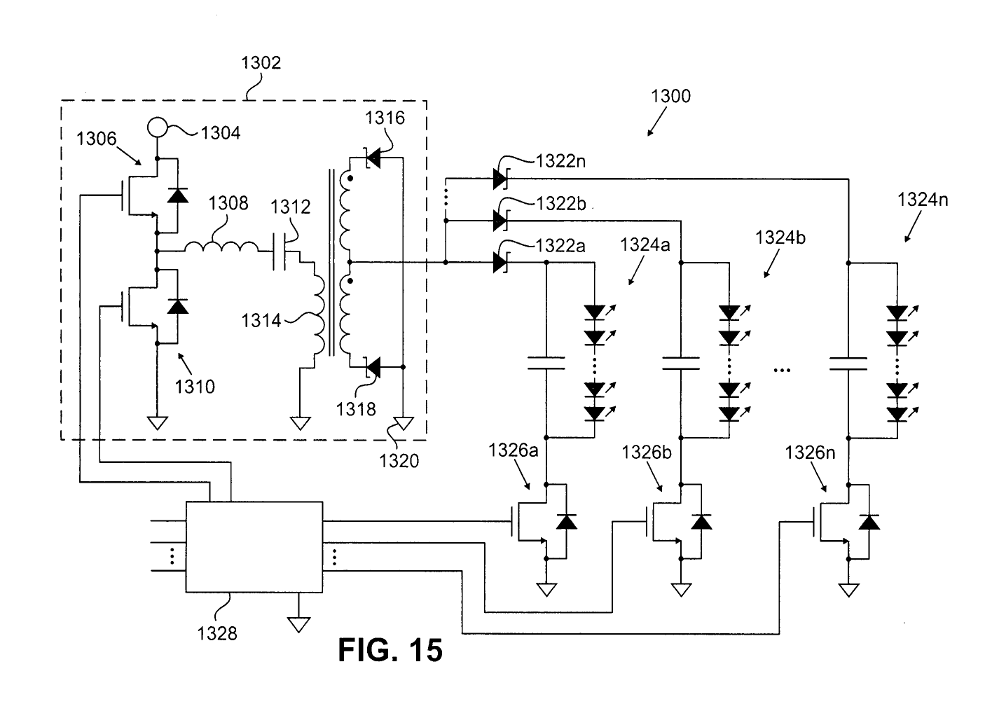

FIG. 16 illustrates an embodiment using a non-isolated variation of the half-bridge converter. Circuit 1400 has current supply subcomponent 1402. Current supply subcomponent 1402 includes voltage input 1404. Voltage input 1404 is connected to high main switch 1406. High main switch 1406 is connected to inductor 1408 and low main switch 1410. Inductor 1408 is connected to capacitor 1412. Capacitor 1412 is connected through diodes 1414a-1414n to output channels 1416a-1416n. Diodes 1414a-1414n function as a rectifier by their anode cathode arrangement Output channels 1416a-1416n include ground referenced channel switches 1418a-1418n operated by ground referenced controller 1420.

The non-isolated half-bridge converter does not have a transformer. This results in a smaller part count while still retaining the half-bridge converter functionality. The non-isolated half-bridge converter operates with the same fixed duty cycle and variable frequency control scheme as the half-bridge converter discussed with respect to FIG. 14. A potential of one-half the supply voltage (voltage input 1404) is still generated across capacitor 1412. The non-isolated half-bridge can also be realized as a resonant or non-resonant converter.

Without a transformer, the output polarity of the full wave rectifier can no longer be ground referenced as drawn in FIG. 15. In other words, the positive and negative output terminals of the rectifier both change with respect to ground. If a single bridge rectifier is used, the channel switches must tolerate a changing potential. This is not a significant problem if the gate drive circuitry is isolated with respect to ground and is instead referenced to the output of the rectifier.

Another approach is to use a full bridge rectifier for each channel. In this arrangement, the channel switches have to standoff (not conduct) for both positive and negative potentials as well as conduct for both positive and negative potentials. The channel switches can also be used to implement the full bridge rectifier for each channel by acting as a synchronous rectifier.

A simpler approach to rectify the AC current of the half-bridge in the SIMO topology is to dedicate individual channels to each positive and negative component. This method is shown in FIG. 15. Diodes 1414a and 1414c and output channels 1416a and 1416c are dedicated to the positive components and diodes 1414b and 1414n with output channels 1416b and 1416n are dedicated to negative components. This offers the advantage of limiting a channel switch to conduct for one polarity making the channel switches much simpler.

Using each output channel as a half wave rectifier is not only simpler than a full wave rectifier, but it is also better suited to switch architecture. Positive channels can be implemented with a PMOS switch and negative switches can be implemented with a NMOS switch so that parasitic diodes are in the correct direction and the sources are ground referenced.

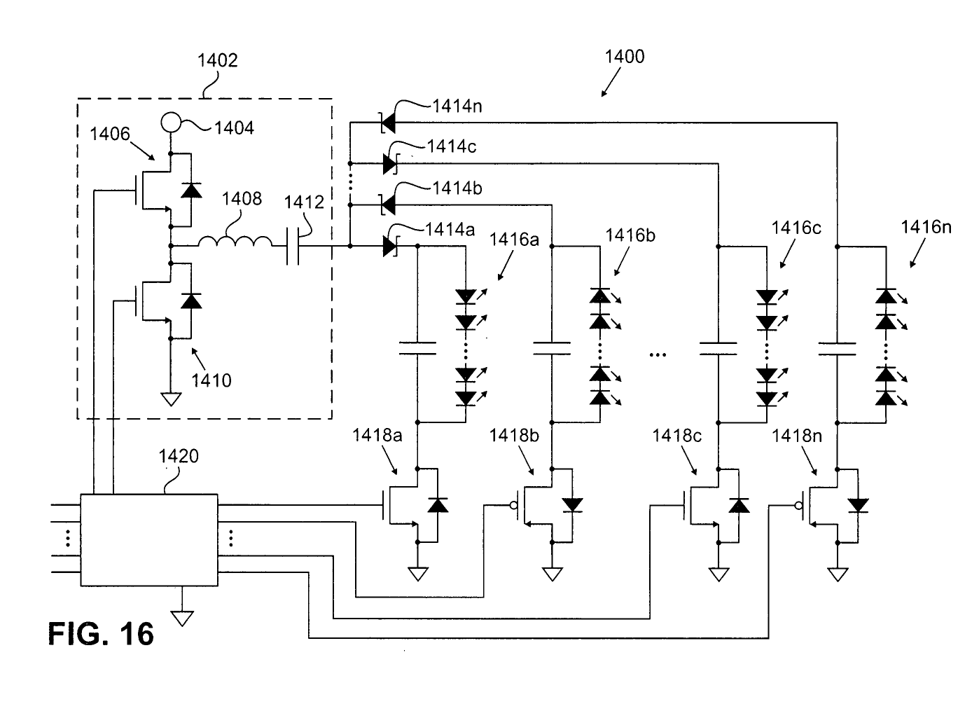

FIG. 17 illustrates circuit 1500, in which a single controller is operable to control multiple power supplies. Circuit 1500 has voltage input 1502 connected to inductors 1504a and 1504b. For exemplary purposes, current supply subcomponents 1501a and 1501b are configured in a boost mode with main switches 1506a and 1506b connected to ground references 1508a and 1508b. Any suitable current supply including those already described, following, or a combination thereof, may be used. Ground referenced controller 1510 handles switching operation for both main switches 1506a and 1506b and all ground referenced channel switches 1513a-1513n and 1515a-1515n for output channels 612a-612n and 614a-614n.

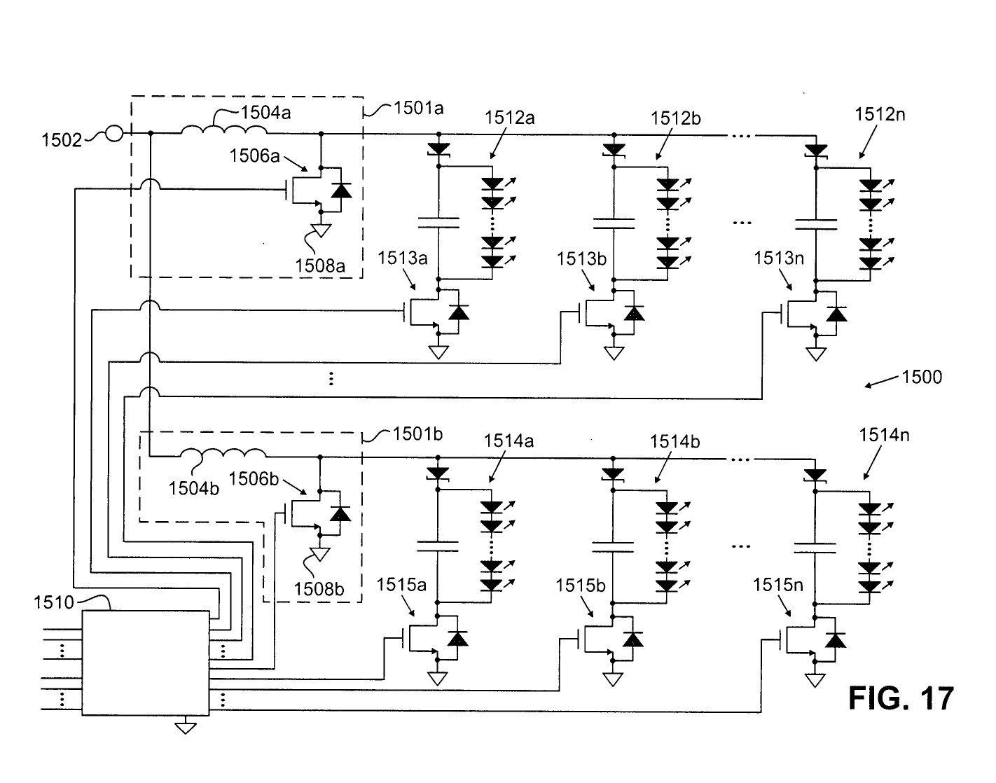

FIG. 18 is diagram illustrating a variant of the buck converter of FIG. 13 shown as circuit 1600. Circuit 1600 illustrates an embodiment utilizing channel switches and a controller that are referenced to a positive voltage. Current supply subcomponent 1602 has voltage input 1604 connected to freewheel diode 1606. Freewheel diode 1606 is connected to main switch 1608 and inductor 1610. Main switch 1608 is connected to ground reference 1626. Inductor 1610 is connected through diodes 1612a-1612n to output channels 1614a-1614n. Output channels 1614a-1614n include channel switches 1616a-1616n connected to positive voltage references 1622a-1622n. Channel switches 161a-1616n are operated by controller 1618 which has positive voltage reference 1620. Channels switches 1616a-1616n are high side referenced and implemented with PMOS devices.

The operation circuit 1600 is essentially the same as its counter part, the buck converter of FIG. 13. FIG. 18 illustrates controller 1618 referenced to the positive voltage reference 1620, but it can also be implemented with the controller 1618 referenced to ground reference 1624. The real benefit is that channel switches 1616a-1616n are all referenced to the same potential.

All of the described embodiments generally operate in a similar way. For simplicity, the operation of the circuit will be described with respect to SIMO power supply circuit 10 shown in FIG. 1. LEDs 28a-28n are an example of a floating load and are two terminal devices that require regulated current and do not need to be referenced to a ground reference. Both the anode and cathode can float without a ground reference. For a particular current, the LED will have a fixed potential across its terminals. For a long string of LEDs, this could be in excess of 100V. Capacitors 22a-22n are connected in parallel with LEDs 28a-28n to sustain the voltage across the LEDs while the channel is not connected to current supply subcomponent 11. Capacitors 22a-22n filter the pulsing current, which results from multiplexing current supply subcomponent 11 between channels 18a-18n, and transforms it into a DC current at the LEDs.

Typical power supplies designed for voltage based loads have channel switches placed at the highest potential of the circuit, which is near the current supply subcomponent. This means that the control signals provided by the controller to the channel switches would have to have a voltage sufficient to bias the channel switch which is at a potential greater than that of the load. Floating loads do not require this configuration.

By referencing controller 30 and channel switches 24a-24n to the same reference, the control signals from controller 30 to channel switches 24a-24n only need to be of a sufficient magnitude to bias channel switches 24a-24n. Controller 30 does not have to overcome the significant voltage present on LEDs 28a-28n. Using the same reference for channel switches 24a-24n and controller 30 offers a higher performance and less costly implementation.

Though generally depicted with channel switches 24a-24n and controller 30 both referenced to a ground reference, circuit 10 may be biased to a higher or lower potential than ground or even inverted such that controller 30 and channel switches 24a-24n are referenced together on the high side as shown in FIG. 18.

Different types of devices can be used for channel switches 24a-24n including NMOS, PMOS, NPN, PNP, and IGBT devices. In a low side configuration, an NMOS device is preferred for the channel switch. In a high side configuration, a PMOS device can be used; however, a PMOS device generally has lower performance characteristics. An NMOS device can be used on a high side configuration, but would require additional internal and external circuitry such as a bootstrap capacitor to drive the gate potential above the source of the NMOS device for the channel switch to work properly. The low side configuration does not require level shifting control signals which provides higher performance with less circuitry and power consumption. Channel diodes 20a-20n are required if there are parasitic diodes in channel switches 24a-24n and the output channels to operate at different voltages. Otherwise channel switches 24a-24n could act a synchronous rectifier in place of channel diodes 20a-20n. Without the presence of diodes 20a-20n, the potential across the channel switch 24a-24n associated with an output channel of a higher potential could go negative and forward bias the parasitic diode when a channel with a lower potential is active.

In some cases, it is possible to eliminate one of channel switches 24a-24n. Current 32 from inductor 14 will flow to the lowest potential available. If more than one of output channels 18a-18n are available, the output channel with the lowest potential will be charged when channel diodes 20a-20n are present. The voltage drop on an LED may vary from device to device due to manufacturing tolerances, but it is otherwise fairly constant. If the potential of LEDs 28a-28n acting as the loads for output channels 18a-18n are known, then the channel switch 24a-24n for the output channel with the highest potential can be eliminated.

After eliminating the channel switch for the output channel with the highest potential, two output channels will be connected to inductor 14 at any time one of the remaining channel switches 24a-24n are closed. Current 32 from inductor 14 will flow to the output channel 18a-18n with the lowest potential which will always be the channel with the closed channel switch. Current will flow to the output channel with the highest potential only if all other channel switches 24a-24n are open. If any other channel switch 24a-24n is closed, then the output channel 18-18n with the lower potential will be charged. In this way, all of the output channels 18a-18n can be independently controlled with the elimination of one of channel switches 24a-24n. This simplifies the design and provides increased efficiency.

Similarly, it is also possible to eliminate one of diodes 20a-20n when the potentials across the output channels 18a-18n are known. Diodes 20a-20n are present to prevent the parasitic diodes from turning on in channel switches 24a-24n. Without the presence of diodes 20a-20n, the anodes of LEDs 24a-24n would be shorted together. When an output channel 18a-18n with a low potential is conducting, the cathodes of LEDs 28a-28n associated with output channels with a higher potential is forced below ground references 26a-26n turning on one or more of the parasitic diodes in channel switches 24a-24n. Given this, the output channel 18a-18n with the lowest potential does not require a diode since the cathode of the LEDs 28a-28n will never go below the ground reference. Therefore, if a channel is guaranteed to have the lowest potential, which is the case for a red LED in a red, blue, and green combination of LEDs, the associated diode can be removed from that individual channel.

For purposes of illustration, a SIMO power supply using a boost mode converter has been described. The invention is equally applicable to a number of other SIMO power supplies including the flyback of FIGS. 3 and 4, the Single Ended Primary Inductor Converter (SEPIC) of FIGS. 5 and 6, the SEPIC variant of FIG. 7, the Boost Integrated Flyback Rectifier Energy Storage DC-DC (BIFRED) converter of FIG. 8, the Cuk of FIG. 9, the single switch buckboost-buck of FIG. 10, the buck-boost of FIG. 11, the buck-boost of FIG. 12, the buck of FIG. 13, the forward converter of FIG. 14, the half-bridge converter of FIG. 15, the non-isolated half-bridge converter of FIG. 16, the multiple inductor power supply of FIG. 17, the positive reference buck converter variant of FIG. 18, etc. In addition to these converters, multiple input multiple output converters can be used as well.

There are a wide variety of control schemes that can be used to regulate currents 34a-34n in each of output channels 18a-18n. The control scheme cycles through output channels 18a-18n one at a time to provide current to each output channel individually with minimal cross regulation between output channels. Channel switches 24a-24n control which output channel is active and receives current from inductor 14. If more than one of channel switches 24a-24n is turned on at a time, the output channel 18a-18n with the lowest potential will be the only one active. However, the channels will share the current from inductor 14 if the channel potentials are identical, which is generally not the case when used for LEDs. In addition to controlling channel switches 24a-24n, the control scheme must also operate main switch 16 to control charging inductor 14. The on time of main switch 16 and channel switches 24a-24n is regulated based on the desired output current for each output channel 18a-18n.

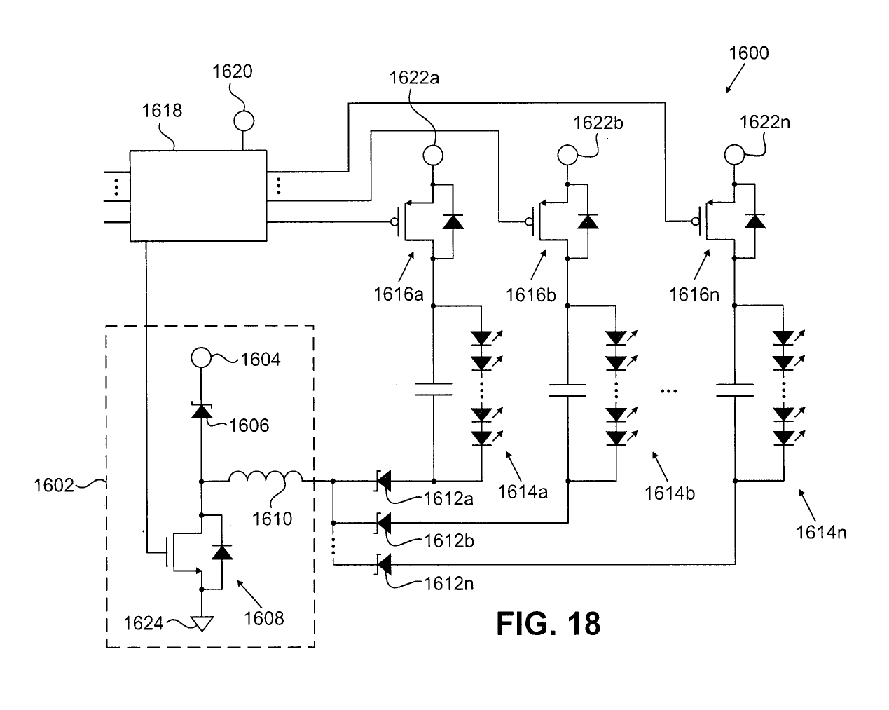

One possible control scheme is an alternating control method, illustrated in the timing diagram of FIG. 19. Control signals from controller 30 are shown as main switch control signal 2200 and channel switch control signals 2202a-2202n. In first channel subinterval 2204a, main switch 16 and the channel switch 24a associated with output channel 18a are turned on. Main switch 16 remains on only for a portion of the full period of first channel subinterval 2204a while inductor 14 is charging. Channel switch 24a remains on to allow inductor 14 to discharge to output channel 18a. Energy is only delivered to output channel 18a when main switch 16 is off. The channel switch 24a remains on for the full duration of subinterval 2204a to prevent an overvoltage condition.

This procedure is repeated for channel 18b in second channel subinterval 2204b. Main switch 16 is turned on to allow inductor 14 to charge. When main switch 16 is turned off, channel switch 24b remains on to allow inductor 14 to discharge to output channel 18b.

The process continues for all output channels until the n^{th} channel is reached. Main switch 16 and channel switch 24n are both turned on for the first portion of n^{th} channel subinterval 2204n. Main switch 16 is turned off allowing inductor 14 to discharge to output channel 18n. The entire sequence then starts over.

The operation of the control scheme differs slightly when applied to the buck converter of FIG. 13, as opposed to a boost converter. For a buck converter energy is delivered to the active output channel 1116a-1116n when main switch 1106 is both on and off. This is also the case for other buck converter based designs such as the Cuk, buckboost-buck, forward converter, isolated half-bridge, non-isolated half bridge, and inverted buck of FIGS. 9, 10, 14, 15, 16, and 18 respectively.

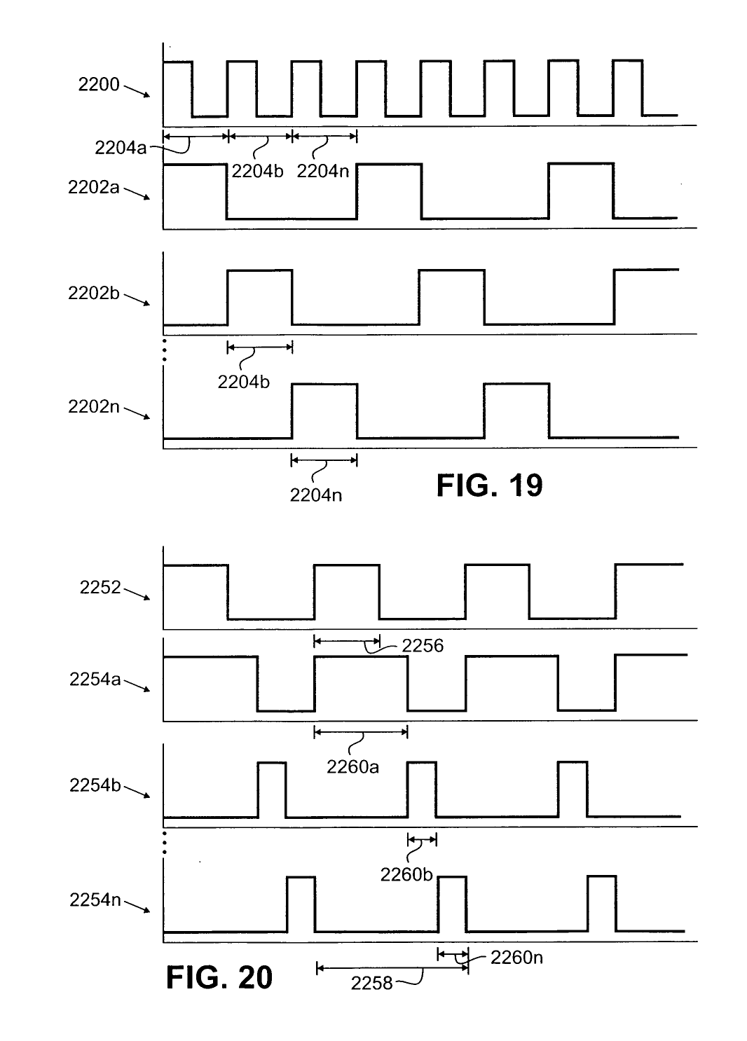

Another possible control scheme is a multiplexed control method illustrated in the timing diagram of FIG. 20. Control signals from controller 30 are shown as main switch control signal 2252 and channel switch control signals 2254a-2254n. In the multiplexed method, main switch 16 is only turned on once for charging subinterval 2256 at the beginning of interval 2258. After main switch 16 turns off, channel switch 24a remains on until enough current has been supplied to output channel 18a ending first channel subinterval 2260a. Channel switch 24b is turned on during second channel subinterval 2260b. The process continues until the n^{th} output channel 18n is reached and supplied current in n^{th} channel subinterval 2260n. This repeats by starting the next charging subinterval.

Both the described alternating and multiplexed methods require at least one channel switch to remain on at all times to prevent an over voltage condition at the output of the current supply subcomponent 11. Therefore, when transitioning between channels, it is preferred to overlap the timing. This is done by keeping the previous channel on while the next channel turns on and turning the previous off when the next channel is fully on. This can be implemented with a fixed overlap time or an adaptive time that detects when a channel switch is fully on before turning off.

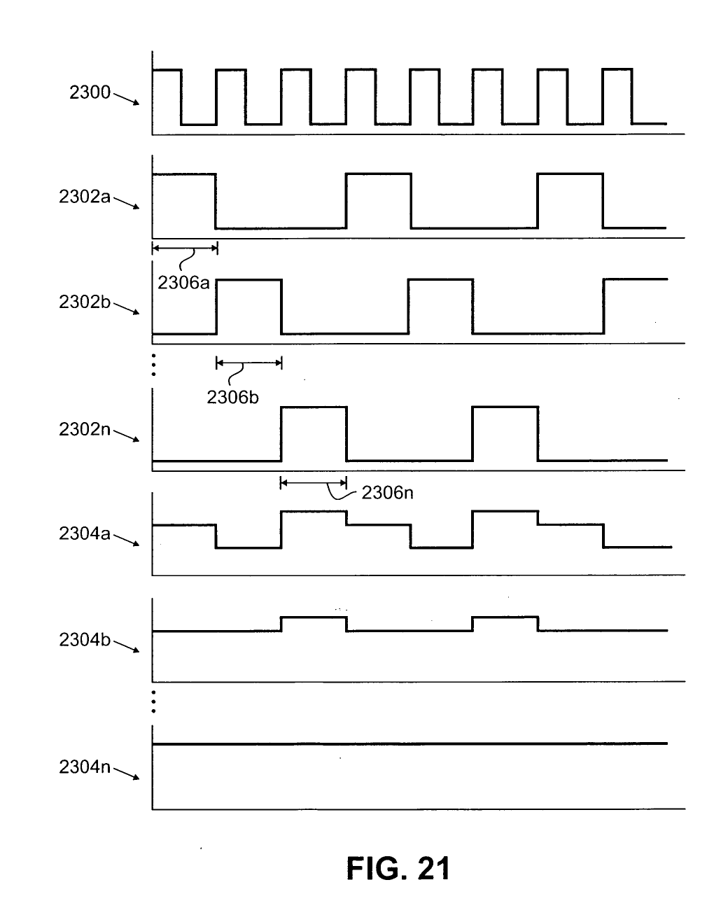

FIG. 21 is a timing diagram illustrating the alternating control method and its associated output waveform. Similar to FIG. 19, the control signals from controller 30 are shown as main switch control signal 2300 and channel switch control signals 2302a-2302n. Output waveform portions 2304a-2304n are the anode voltages of the respective LEDs. Both the anode and cathode of LEDs 28a-28n can float with respect to ground. Even though the voltage across each output channel 18a-18n is different, the current supplied to each output channel 18a-18n can be regulated independently. When channel switches 24a-24n are located on the low side, the anode voltage of all the output channels 18a-18n that are turned off will float up such that high side diodes 20a-20n turn off and the selected output channel receives all of the energy delivered by inductor 14. In the example shown in FIG. 21, output channels 18a-18n are shown having different voltages where output channel 18a is at the lowest potential and output channel 18n is at the highest potential. This results in output waveform portion 2304a showing a change in voltage with every channel subinterval 2306a-2306n whereas output waveform 2304n is constant because it has the highest potential and does not need to change to reverse bias its associated diode.

Special considerations apply for some converter topologies. When using the flyback power supply shown in FIGS. 3 and 4 and the SEPIC power supply shown in FIGS. 5 and 6, the channel switches are exposed to a negative potential at the secondary winding. Therefore, the channel diodes on the output channels are not only included to allow the channels to operate at different voltages, but also to accommodate the negative voltages present. In this application, the channel diodes are providing the same function as the diodes present in the single output counter part. Without the diodes, the parasitic diodes in the channel switches may turn on when the main switch is on which is undesirable.

The Cuk converter shown in FIG. 9 has a negative output voltage and therefore the channel switches are exposed to a negative voltage while on or off. In the Cuk topology, PMOS devices are preferred so that the parasitic diode is oriented such that it does not turn on when the switch is off while retaining a ground referenced. The gate of a PMOS is driven with a negative potential. This is well understood in the field and can be accommodated using well known techniques. Though more complicated than the positive output voltage, the ground reference PMOS still has higher performance and a less costly implementation than referencing to the potential of each output channel. An NMOS device could also be used in the case of negative voltages by connecting the source to the load such that the parasitic diode is not forward biased when the switch is off. In this configuration the gate driver would be referenced to the source, and would have to tolerate the negative potential of the load because the source is not ground referenced. This negative potential is also present in other converter topologies such as the buckboost-buck, single switch buck-boost, non-isolated half-bridge, and inverted buck in FIGS. 10, 11, 16, and 18 respectively.

The half-bridge converter shown in FIGS. 15 and 16 benefits from synchronizing the switching of channels with the zero crossing of the inductor current. In other topologies, channel switches are synchronized with the main switch as this is when the inductor current is at its lowest magnitude. For the half-bridge, the inductor current is at its highest point when the main switch changes. The channel switches can be forced to transition this high current magnitude, but doing so results in reverse recovery losses in the channel diodes. Synchronizing with the zero crossing of the inductor reduces these losses with a trade off of increased control complexity.

The non-isolated half-bridge converter shown in FIG. 16 requires a more complex control technique. The polarity of the inductor current is considered when transitioning the channel switches. If multiple channel switches are on, current flow from the inductor will automatically transition between channels from a positive channel to a negative channel as it moves through a zero transition. Therefore, it is preferred to have both a positive and negative channel on at the same time causing the transition to the next channel of a given polarity to be guaranteed that the opposing polarity is conducting. As in the other described embodiments, if multiple output channels are on at the same time, the channel with the lowest potential will be the only one active.

The disclosed invention is a method for supplying power to floating loads. Floating loads do not require a specific reference such as a ground reference. A current source is connected to a plurality of output channels. Each of the output channels has a load and a channel switch with a reference voltage. A controller is connected to the channel switches to control the flow of current from the current source to the loads of the output channels. In exemplary embodiments, the controller shares the reference voltage of the channel switches.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A multiple output power supply comprising:
a current supply;
a plurality of output channels coupled to the current supply, each output channel comprising a load and a channel switch having a reference voltage, wherein all of the channel switches share the same reference voltage; and
a controller that operates the control switches of the output channels to supply current from the current supply to the loads of the output channels.

2. The multiple output power supply of claim 1 wherein the controller shares the reference voltage of the channel switches of the output channels.

3. The multiple output power supply of claim 1 wherein each of the channel switches comprises a device selected from the group consisting of: an NMOS device, a PMOS device, a NPN device, a PNP device, and an IGBT device.

4. The multiple output power supply of claim 1 wherein the load comprises one or more light emitting diodes.

5. The multiple output power supply of claim 4 wherein the load further comprises a capacitor in parallel with the light emitting diodes.

6. The multiple output power supply of claim 1 wherein the reference voltage of the channel switches is a ground reference.

7. The multiple output power supply of claim 1 wherein the reference voltage of the channel switches is a positive voltage reference.

8. The multiple output power supply of claim 1 wherein the output channel further comprises a diode between the current supply and the load.

9. The multiple output power supply of claim 1 wherein the current supply and the plurality of output channels is configured as a single inductor multiple output supply.

10. The multiple output power supply of claim 9 wherein the single inductor multiple output supply is selected from the group consisting of boost, flyback, forward converter, single ended primary inductor converter (SEPIC), Cuk, boost integrated flyback rectifier energy storage DC-DC (BIFRED), buck, buck-boost, single switch buck-boost, single switch buckboost-buck, half-bridge, full-bridge, and non-isolated half-bridge.

11. The multiple output power supply of claim 9 wherein the single inductor multiple output supply is controlled by the controller.

12. The multiple output power supply of claim 1 wherein the current supply comprises:
a voltage source;
an inductor coupled between the voltage source and the plurality of output channels; and
a main switch coupled between the inductor and a ground reference operated by the controller.

13. The multiple output power supply of claim 1 wherein the current supply comprises:
a voltage source;
a main switch coupled to the voltage source and operated by the controller;
an inductor coupled between the control switch and the plurality of output channels; and
a diode coupled between the main switch and a ground reference.

14. The multiple output power supply of claim 1 wherein the current supply comprises:
a coupled inductor having a primary winding and a secondary winding wherein the secondary winding is coupled to the plurality of output channels;
a voltage source coupled to the primary winding of the coupled inductor; and
a main switch coupled between the primary winding and a ground reference operated by the controller.

15. The multiple output power supply of claim 14 further comprising a capacitor coupled between the main switch and secondary winding of the coupled inductor.

16. An output channel for a single inductor multiple output power supply having a controller with a voltage reference comprising:
a terminal for accepting energy from the single inductor multiple output power supply;
a load coupled to the terminal; and
a channel switch coupled to the load sharing the voltage reference of the controller, wherein the channel switch is operated by the controller to control the transfer of energy from the terminal to the load.

17. The output channel of claim 16 wherein the load comprises one or more light emitting diodes.

18. The output channel of claim 17 wherein the load further comprises a capacitor in parallel with the light emitting diodes.

19. The output channel of claim 16 wherein the controller and the channel switch are ground referenced.

20. The output channel of claim 16 wherein the reference voltage of the controller and the channel switches is a positive voltage reference.

21. The output channel of claim 16 further comprising a diode coupled between the terminal and the load.

22. A controllable power supply comprising:
a plurality of floating loads;
a single energy storage element coupled to the plurality of floating loads; and
a plurality of channel switches with a common reference voltage, wherein the plurality of channel switches are coupled to the plurality of floating loads and control the transfer of energy from the single energy storage element to the plurality of floating loads;

23. The controllable power supply of claim 22 further comprising a controller with a reference voltage wherein the controller is coupled to the plurality of channel switches for operating the plurality of channel switches, and the controller and the plurality of channel switches have the same reference voltage.

24. The controllable power supply of claim 22 wherein the transfer of energy from the single energy storage element further comprises of transferring energy from an energy source to the plurality of floating loads.

25. The controllable power supply of claim 22 wherein the reference voltage of the plurality of channel switches is a ground reference.

26. The controllable power supply of claim 22 wherein the reference voltage of the plurality of channel switches is a positive voltage reference.

27. The controllable power supply of claim 22 wherein at least one of the plurality of channel switches comprises a device selected from the group consisting of: an NMOS device, a PMOS device, a NPN device, a PNP device, and an IGBT device.

28. The controllable power supply of claim 22 wherein the single energy storage element is an inductor and the controllable power supply further comprises:
a voltage source coupled to the inductor; and
a main switch coupled between the inductor and a ground reference.

29. The controllable power supply of claim 22 wherein the single energy storage element is an inductor and the controllable power supply further comprises:
a voltage source;
a main switch coupled between the voltage source and the inductor; and
a diode coupled between the main switch and a ground reference.

30. The controllable power supply of claim 22 wherein the single energy storage element is a coupled inductor having a primary and secondary winding wherein the secondary winding is coupled to the plurality of floating loads and the controllable power supply further comprises:
a voltage source coupled to the primary winding of the coupled inductor; and
a main switch coupled between the primary winding of the coupled inductor and a ground reference.

31. The controllable power supply of claim 30 further comprising a capacitor coupled between the main switch and secondary winding of the coupled inductor.

32. The controllable power supply of claim 22 is a single inductor multiple output power supply selected from the group consisting of: boost, flyback, forward converter, single ended primary inductor converter (SEPIC), Cuk, boost integrated flyback rectifier energy storage DC-DC (BIFRED), buck, buck-boost, single switch buck-boost, single switch buckboost-buck, half-bridge, full-bridge, and non-isolated half-bridge.

33. The controllable power supply of claim 32 further comprising a controller that controls the single inductor multiple output power supply.

34. The controllable power supply of claim 22 further comprising:
a second plurality of floating loads;
a second single energy storage element coupled to the second plurality of floating loads; and
a second plurality of channel switches with a common reference voltage, wherein the second plurality of channel switches are coupled to the second plurality of floating loads and control the transfer of energy from the second single energy storage element to the second plurality of floating loads.

35. The controllable power supply of claim 22 wherein at least one of the floating loads comprises a string of light emitting diodes.

36. The controllable power supply of claim 35 wherein the floating load further comprises a capacitor in parallel with the string of light emitting diodes.
